(19) United States
(12) Patent Application Publication
(10) Pub. No.: US 2008/0291604 A1
(43) Pub. Date: Nov. 27, 2008

(54) Electrolytic Capacitor

(75) Inventor: Chojiro Kuriyama, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto-shi (JP)

(21) Appl. No.: 11/628,174

(22) PCT Filed: May 30, 2005
(86) PCT No.: PCT/JP05/09861

§ 371 Date: Nov. 30, 2006

(30) Foreign Application Priority Data
May 31, 2004 (JP) 2004-160439

(51) Int. Cl. H01G 9/042

(52) U.S. Cl. 361/502

(57) ABSTRACT

An electrolytic capacitor (A1) of the present invention includes an anode (2), a cathode (3) and an electrolyte (4) intervening between the anode (2) and the cathode (3). The anode (2) includes a porous sintered body (21) made of valve metal and having a surface on which an oxide film as a dielectric layer (23) is formed, and an anode wire (22) electrically connecting the porous sintered body (21) to a positive external connection terminal (7A). The cathode (3) includes a polarizable electrode (31) for forming an electric double layer at an interface with the electrolyte (4), and a collector electrode (32) electrically connecting the polarizable member (31) to a negative external connection terminal (7B).

### TECHNICAL FIELD

The present invention relates to an electrolytic capacitor.

### BACKGROUND ART

Conventionally, electric double layer capacitors are used for a backup power supply of an electronic device such as a mobile phone, for example. Electric double layer capacitors are also used for a power storage device provided with a solar battery, and a motor power supply or a regenerative energy device of a so-called hybrid car, for example.

FIG. 7 shows an example of such an electric double layer capacitor. The electric double layer capacitor X includes an anode 91 and a cathode 92. The anode 91 includes a polarizable electrode 91a made of minute particles of activated carbon, whereas the cathode 92 includes a polarizable electrode 92a similarly made of minute particles of activated carbon. An electrolyte 93 is loaded between the polarizable electrodes 91a and 92a. In the electric double layer capacitor X, at the interface between the electrolyte 93 and the polarizable electrode 91a, 92a, and more specifically, at the interface between the electrolyte 93 and the activated carbon particles, an electric double layer is formed in which positive ions and negative ions are distributed with the intervention of the interface. When the capacitor is used for a power storage device, the electric double layer is utilized for charging. When the capacitor is used for a power supply, the charge stored in the electric double layer is supplied to a load.

In the electric double layer capacitor X, the distance between the positive ions and the negative ions in the electric double layer formed at the polarizable electrodes 91a and 92a is extremely small and about the size of one molecule. Therefore, the capacitance per unit area of the electric double layer is high. Further, since the polarizable electrodes 91a and 92a are made of activated carbon particles, the surface area per unit volume of the electric double layer is large. Therefore, the electric double layer capacitor has a high capacitance despite of the small size, and hence, is recently used for a power supply or a power storage device.

The storage energy of a capacitor is expressed as CV²/2 (C: capacitance, V: voltage), and a higher voltage and capacitance provides greater storage energy. When a capacitor is used for a power supply as backup power, it is preferable to increase the total storage energy by increasing the storage energy per volume or weight (energy density) and to increase the supply voltage as much as possible. Particularly, to supply the same power, the output current can be reduced by increasing the supply voltage. Therefore, to increase the voltage of the capacitor is important for reducing the loss such as the internal resistance of the capacitor and for enhancing the power supply efficiency.

However, when a voltage exceeding the withstand voltage is applied to the electric double layer, bubbles are formed in the electrolyte due to electrolysis, so that the electric double layer does not function as a capacitor. Therefore, the electric double layer capacitor cannot be used by itself as a power supply exceeding the withstand voltage. To be compatible with the power supply of such a high voltage, a plurality of cells of electric double layer capacitors need to be connected in series.

For instance, when a dilute aqueous solution of sulfuric acid is used as the electrolyte 93, the withstand voltage of the electric double layer formed at each of the polarizable electrodes 91a and 92a is about 1.0 to 1.2 V. Therefore, to use a voltage higher than the withstand voltage, a plurality of cells of the electric double layer capacitors need to be connected in series.

In this case, in order for the electric double layer capacitor X to properly exhibit its function, it is preferable to make the voltages of the cells generally equal to each other. However, due to the variation in capacitance and so on, voltage varies largely between the cells, and it is not easy to equally distribute the voltage. Therefore, the electric double layer capacitor cannot sufficiently respond to the demand for an increase in voltage which requires a greater number of cells.

As for a solid electrolytic capacitor such as a tantalum electrolytic capacitor or a niobium oxide capacitor, minute particles having a high CV value are developed recently, and the capacitance is being increased by using a porous sintered body made of such minute particles. However, when the CV value is increased by increasing the specific surface area of minute particles, the withstand voltage decreases. Therefore, it is difficult even for such a high capacitance solid electrolytic capacitor to be compatible with high voltage applications.

As a method to realize a high voltage resistance of an electrolytic capacitor made by using minute particles having a high CV value, it may be considered to employ the cathode structure of a wet electrolytic capacitor. However, with this kind of cathode structure, it is impossible to flow a great amount of current. That is, although the withstand voltage can be increased by the employment of the cathode structure of a conventional wet electrolytic capacitor, the withstand voltage is exceeded when a great amount of current flows, so that there is a limitation on the current which can be caused to flow through the capacitor.

As described above, although there is a demand for a capacitor which has a high voltage resistance and a high capacitance and preferably is capable of flowing a great amount of current, the structures of a conventional dry capacitor and a wet capacitor cannot respond to such a demand.
Patent Document 1: JP-A-2003-92234

### DISCLOSURE OF THE INVENTION

The present invention is conceived under the above-described circumstances, and it is an object of the present invention to provide a solid electrolytic capacitor which is capable of realizing a high capacitance and a high voltage resistance and flowing a great amount of current.

According to the present invention, there is provided an electrolytic capacitor comprising an anode, a cathode, and an electrolyte intervening between the anode and the cathode. The anode comprises a porous sintered body made of valve metal and having a surface on which an oxide film as a dielectric layer is formed, and a first conductive member electrically connecting the porous sintered body to a positive external connection terminal. The cathode comprises a polarizable member for forming an electric double layer at an interface with the electrolyte, and a second conductive member electrically connecting the polarizable member to a negative external connection terminal.

Preferably, the electric double layer has a capacitance which is greater than the capacitance of the dielectric layer.

Preferably, the valve metal is niobium, tantalum or a compound of these.

Preferably, the polarizable member of the cathode is made of activated carbon.

Preferably, a partition wall which allows the electrolyte to pass therethrough is provided between the anode and the cathode.

Preferably, the electrolytic capacitor further comprises a case divided into a plurality of chambers. The anode, the cathode and the electrolyte are provided in each of the chambers of the case, and the anode and the cathode in adjacent chambers are electrically connected to each other in series.

Preferably, the electrolytic capacitor further comprises a case divided into a plurality of chambers. The anode, the cathode and the electrolyte are provided in each of the chambers of the case. The respective first conductive members of the anodes are electrically connected to each other, and the respective second conductive members of the cathodes are electrically connected to each other.

Preferably, a plurality of anodes and a plurality of cathodes are provided. The respective first conductive members of the anodes are electrically connected to each other, and the respective second conductive members of the cathodes are electrically connected to each other.

With the electrolytic capacitor according to the present invention, the withstand voltage of the dielectric layer is higher than that of the electric double layer, and further, it is possible to increase the voltage at the dielectric layer. Therefore, when the electrolytic capacitor is used for a power supply, the capacitor can be compatible with high voltage power supply by increasing the withstand voltage of the dielectric layer.

Further, in charging, by making the capacitance of the electric double layer higher than that of the dielectric layer, the same level of electrostatic energy as that stored in the dielectric layer can be stored in the electric double layer while keeping the voltage to be applied to the electric double layer lower than the withstand voltage. Therefore, the withstand voltage of the entire electrolytic capacitor can be increased while keeping the voltage at the electric double layer lower than the withstand voltage.

In the electrolytic capacitor according to the present invention, the polarizable electrode is formed by using activated carbon, so that the surface area of the cathode is large. Therefore, in discharging the stored electrostatic energy, it is possible to increase the output current as the electrolytic capacitor while keeping the current per unit area of the electric double layer small.

### BRIEF DESCRIPTION OF THE DRAWINGS

FIG. 1 is a sectional view showing an example of electrolytic capacitor according to the present invention.

FIG. 2 is an enlarged view showing a principal portion of the electrolytic capacitor according to the present invention.

FIG. 3 is an enlarged view showing a principal portion of the electrolytic capacitor according to the present invention.

FIG. 4 is a sectional view showing another example of electrolytic capacitor according to the present invention.

FIG. 5 is a sectional view showing another example of electrolytic capacitor according to the present invention.

FIG. 6 is a sectional view showing another example of electrolytic capacitor according to the present invention.

FIG. 7 is a sectional view showing a principal portion of an example of conventional electrolytic capacitor.

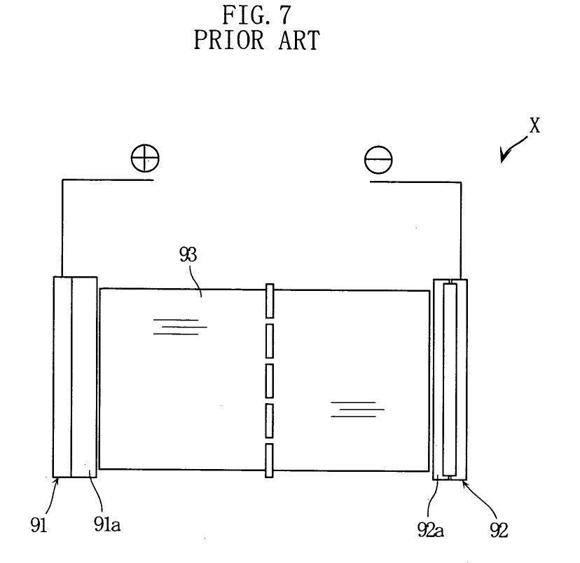

### BEST MODE FOR CARRYING OUT THE INVENTION

Preferred embodiments of the present invention will be described below with reference to the accompanying drawings.

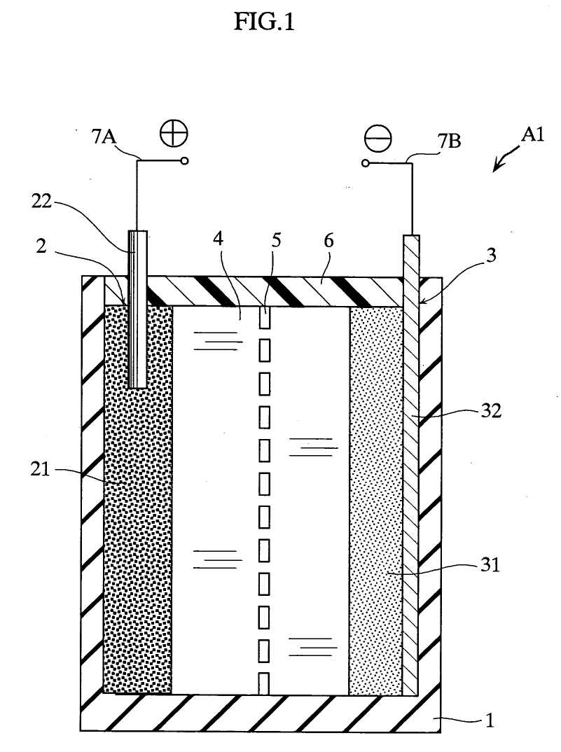

FIGS. 1-3 show an example of electrolytic capacitor according to the present invention. As shown in FIG. 1, the electrolytic capacitor A1 includes an anode 2, a cathode 3, an electrolyte 4, a partition wall 5, and a case 1 accommodating these parts.

The case 1 is made of an insulating rein and having opposite side walls to which the anode 2 and the cathode 3 are attached.

The anode 2 includes a porous sintered body 21 of niobium as a valve metal, and an anode wire 22 partially embedded in the porous sintered body 21. The reason why a porous sintered body of niobium is used as the anode 2 is that an oxide film as a dielectric layer 23, which will be described later, can be properly formed by chemically treating the porous sintered body. Further, since the withstand voltage of the oxide film can be made relatively high, it is easy to realize a high voltage resistance with respect to the electrolytic capacitor A1.

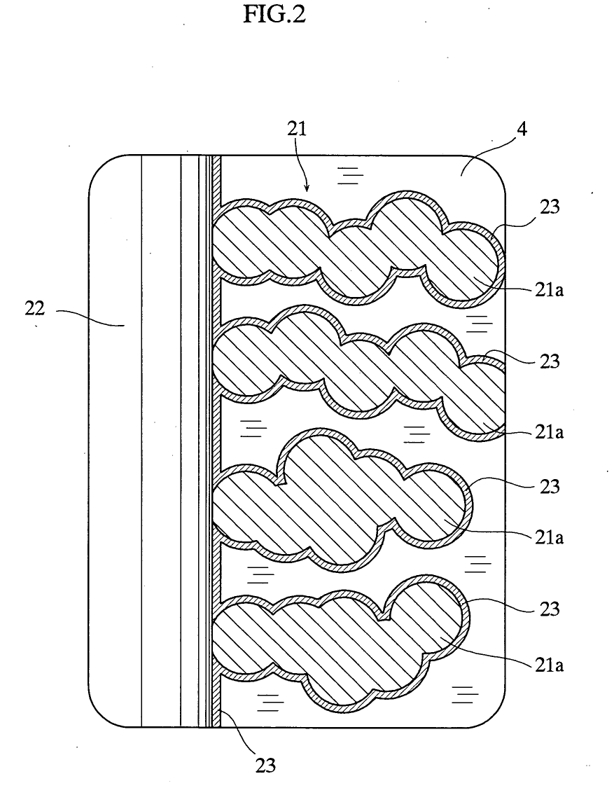

As shown in FIG. 2, the porous sintered body 21 is made of a great number of minute particles 21a of niobium bonded to each other. These niobium particles 21a are electrically connected to the anode wire 22. A dielectric layer 23 made of an oxide film such as a niobium pentoxide film is formed on surfaces of the niobium particles 21a and the anode wire 22.

For instance, the anode 2 is formed as follows. First, niobium particles are loaded into a mold and press-worked, with the anode wire 22 partially embedded in the particles, whereby a porous body of niobium is prepared. The porous body is then sintered to obtain a porous sintered body 21 of niobium. Subsequently, with the porous sintered body 21 immersed in a treatment liquid such as an aqueous solution of phosphoric acid, a direct current is applied to perform anodic oxidation. As a result, a dielectric layer 23 is formed on the inner and outer surfaces of the porous sintered body 21 and the obverse surfaces of the anode wire 22.

Similarly to the porous sintered body 21, the anode wire 22 is made of niobium. The anode wire 22 is electrically connected to an external connection terminal 7A (positive terminal) utilized for the external connection of the electrolytic capacitor A1.

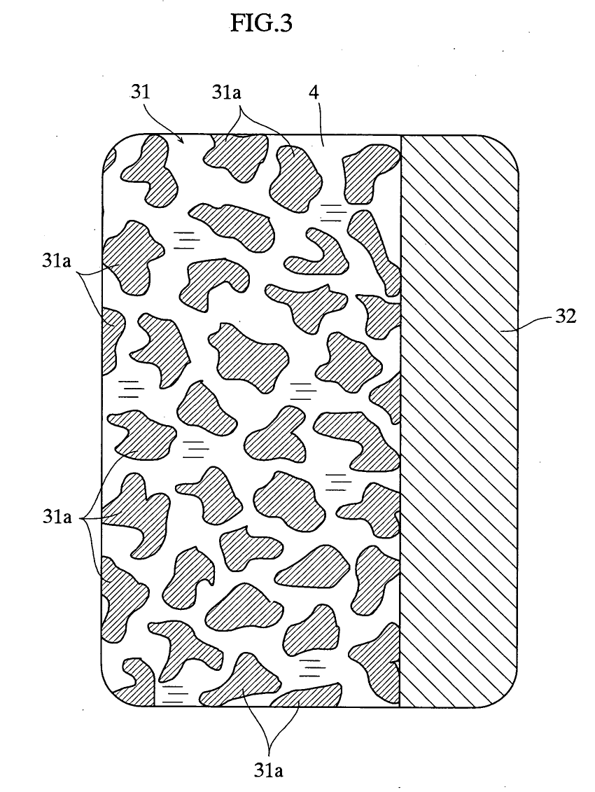

The cathode 3 includes a polarizable electrode 31 and a collector electrode 32. As shown in FIG. 3, the polarizable electrode 31 is formed by kneading minute particles 31a of e.g. activated carbon with a binder (not shown) and bonded to the collector electrode 32. To enhance the electrical conduction between the particles 31a of activated carbon, so-called “carbon nano black” may be added. The obverse surfaces of the particles 31a of activated carbon are finely irregular, and the surface area per unit volume is larger than that of the porous sintered body 21 of e.g. niobium.

Since the surface area per unit volume of activated carbon is larger than that of the porous sintered body of niobium or tantalum, for example, the capacitance per unit area of the electric double layer formed at the cathode 3 can be increased by the provision of the polarizable electrode 31 made of activated carbon in the cathode 3.

When a voltage is applied to the interface between the polarizable electrode 31 and the electrolyte 4, charged ions adhering to the surface of the polarizable electrode 31 and ions in the electrolyte 4 which are in contact with the surface of the polarizable electrode 31 are distributed, with the interface intervening therebetween. In this way, a so-called electric double layer is formed.

Unlike the instance, such as in porous sintered body 21, in which charge builds up with the intervention of a physically formed film such as the dielectric layer 23, the distance between the positive ions and the negative ions in the electric double layer (corresponding to the thickness of the electric double layer) is about the size of one molecule. Therefore, the capacitance per unit area of the electric double layer is large.

The collector electrode 32 is bonded to the polarizable electrode 31 with conductive resin (not shown), for example. The collector electrode 32 is electrically connected to an external connection terminal 7B (negative terminal) utilized for the external connection of the electrolytic capacitor A1.

The electrolyte 4 is loaded in the case 1 and impregnated into the porous sintered body 21 of the anode 2 and the polarizable electrode 31 of the cathode 3. As the electrolyte 4, use may be made of an aqueous solution of sulfuric acid, for example. At the interface between the electrolyte 4 and the porous sintered body 21, positive charge accumulates on the surface of the porous sintered body 21, whereas negative charge accumulates on the electrolyte 4, with the dielectric layer 23 intervening therebetween, so that the storage function is obtained. In this way, a capacitor is formed by the dielectric layer 23. On the other hand, at the interface between the electrolyte 4 and polarizable electrode 31, the above-described electric double layer is formed. Specifically, positive charge accumulates on the electrolyte 4 side, whereas negative charge accumulates on the polarizable electrode 31 side, whereby the storage function is obtained. In this way, a capacitor is formed by the electric double layer.

The partition wall 5 serves to prevent the porous sintered body 21 of the anode 2 and the polarizable electrode 31 of the cathode 3 from unduly coming into contact with each other to be electrically connected to each other. The partition wall 5 comprises a plate made of an insulating material and formed with a plurality of small pores and allows the electrolyte 4 to pass therethrough.

Sealing resin 6 is provided to cover the upper opening of the case 1 and serves to prevent the electrolyte 4 from leaking and prevent the porous sintered body 21 and the polarizable electrode 31 from being unduly connected electrically to a conductive member other than the electrolytic capacitor A1.

The operation and advantages of the electrolytic capacitor A1 will be described below.

As described above, the capacitance per unit area of the dielectric layer 23 is smaller than that of the electric double layer. Therefore, the withstand voltage of the dielectric layer is higher than that of the electric double layer. Since the voltage across the terminal 7a and the terminal 7b of the electrolytic capacitor A1 is the sum of the withstand voltage of the electric double layer of the cathode 3 and the withstand voltage of the dielectric layer 23 of the anode, the voltage can be increased as compared with a conventional electric double layer capacitor which utilizes only the electric double layer.

Therefore, even with the use of a single electrolytic capacitor A1, it is possible to achieve a sufficiently great increase in voltage which cannot be achieved without connecting a plurality of cells of electric double layer capacitors in series when conventional double layer capacitors are used.

For instance, a porous sintered body of 1 cm²×1 mm and made of 100 KVC/g of niobium powder has a capacitance of 30 KCV per pellet. By chemically treating the sintered body at 100 V, a dielectric layer of 3000 μF can be formed. On the other hand, at the polarizable electrode 31 made of minute particles of activated carbon, an electric double layer of no less than e.g. 200,000 μF can be formed.

It is now assumed that the electrolytic capacitor A1 includes a dielectric layer of 3000 pF and the polarizable electrode 31 capable of forming an electric double layer of 200,000 pF. When a voltage is applied across the terminals 7a and 7b of this electrolytic capacitor A1 so that 50V is applied to the dielectric layer 23, about 0.75V (=50·C1/(C1+C2) where C1 is the capacitance of the dielectric layer 23, whereas C2 is the capacitance of the electric double layer) is applied to the electric double layer formed at the cathode 3. In this way, while keeping the electric double layer lower than the withstand voltage (about 1.0V), the capacitor can be charged at a high voltage of 50V or higher, and power supply at a voltage of 50V or higher is possible when the capacitor is used as a power source.

Further, even when an intended high voltage cannot be obtained without connecting a plurality of cells of electrolytic capacitors A1 in series, the number of cells which need to be connected to obtain the voltage is smaller than the case in which the cells comprising conventional electric double layer capacitors are used.

In this way, the number of cells to be connected in series can be reduced by using the electrolytic capacitors A1. Therefore, even when voltage varies between the cells, uniform voltage distribution between the cells can be performed relatively easy.

Moreover, as described above, the capacitance per unit area of the electric double layer of the cathode 3 is larger than that of the dielectric layer 23 of the anode 2. Therefore, when a voltage is applied across the terminal 7A and the terminal 7B, the voltage applied to the electric double layer of the cathode 3 is smaller than that applied to the dielectric layer 23 of the anode 2. Therefore, in the electrolytic capacitor A1, generally equal electrostatic energy can be stored in the electric double layer of the cathode 3 and in the dielectric layer of the anode 2 while keeping the voltage applied to the electric double layer lower than that applied to the dielectric layer 23.

Therefore, with the electrolytic capacitor A1, a high voltage supply is possible by increasing the voltage at the dielectric layer 23 of the anode 2 while keeping the voltage at the electric double layer lower than the withstand voltage.

The dielectric layer 23 formed on the anode 2 by utilizing the porous sintered body 21 has a relatively large surface area, and the electric double layer formed on the cathode 3 by the provision of the polarizable electrode 31 made of activated carbon particles also has a relatively large surface. Therefore, the capacitance at each of the electrodes is relatively high, so that the capacitance of the electrolytic capacitor can be increased.

In this way, with the electrolytic capacitor A1, a high capacitance and a high voltage resistance can be realized. Therefore, when the capacitor is used as a power supply, the same power can be supplied by increasing the supply voltage while reducing the supply current. Therefore, the loss due to the internal resistance of the power supply can be reduced, so that the power supply can be performed efficiently.

Since the amount of current per unit area of the anode 2 and the cathode 3 of the electrolytic capacitor A1 can be reduced, charge with a relatively great amount of current is possible, and the capacitor can be suitably used as a power supply for supplying a great mount of current.

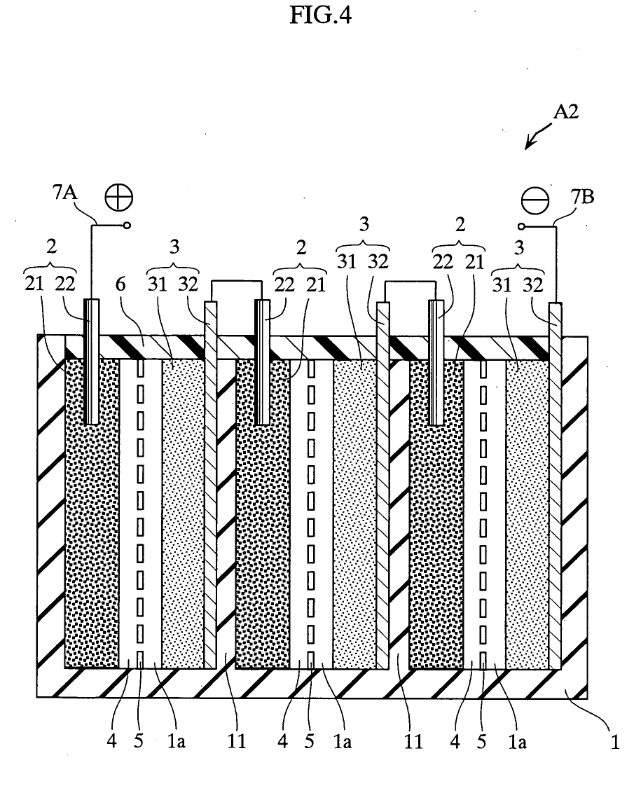

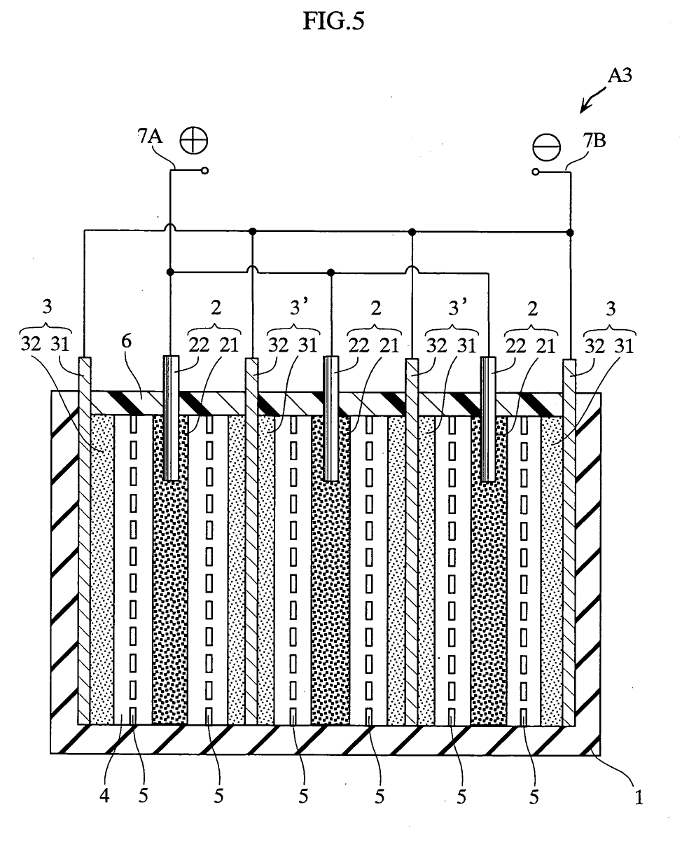

FIGS. 4 and 5 show other embodiments of the present invention. In these figures, the elements which are identical or similar to those of the foregoing embodiment are designated by the same reference signs as those used for the forgoing embodiment.

The electrolytic capacitor A2 shown in FIG. 4 is provided by connecting a plurality of cells of electrolytic capacitors A1 shown in FIG. 1 in series.

The case 1 is divided into three chambers 1a by two inner plates 11. In each of the chambers 1a, the electrolytic capacitor A1 shown in FIG. 1 is provided. Specifically, an anode 2, a cathode 3, and a partition wall 5 providing insulation between the anode and cathode are arranged in each of the chambers 1a. The chamber 1a is filled with electrolyte 4. In this embodiment, the anode wire 22 of the anode 2 and the collector electrode 32 of the cathode 3 which are arranged to sandwich the inner plate 11 are electrically connected to each other. With this arrangement, in the electrolytic capacitor A2, the plurality of anodes 2 and cathodes 3 are electrically connected in series.

According to this embodiment, the voltage of the electrolytic capacitor A2, i.e., the voltage across the external connection terminals 7A and 7B can be increased. Therefore, the capacitor is advantageous for realizing a high voltage resistance for use as a power supply. It is to be noted that the number of chambers 1a is not limited to three.

The electrolytic capacitor A3 shown in FIG. 5 includes a plurality of anodes 2 and a plurality of cathodes 3, 3′. The plurality of anodes 2 are connected to each other and connected to the terminal 7A, whereas the plurality of cathodes 3, 3′ are connected to each other and connected to the terminal 7B. Two cathodes 3 are attached to opposite side walls of the case 1, and the anodes 2 and the cathodes 3′ are alternately arranged between the cathodes 3. Unlike the cathodes 3, each of the cathodes 3′ includes polarizable electrodes 31 provided on opposite sides of the collector electrode 32. Three anode wires 22 and four collector electrodes 32 are electrically connected to the external connection terminals 7A and 7B, respectively. With this arrangement, in the electrolytic capacitor A3, the plurality of anodes 2 and the plurality of cathodes 3, 3′ are electrically connected in parallel, respectively.

The electrolytic capacitor A3 shown in FIG. 5 has the substantially same advantages as those of the structure in which a plurality of cells each comprising the electrolytic capacitor A1 are connected in parallel.

Therefore, according to this embodiment, a great amount of electrostatic energy can be stored in the electrolytic capacitor A3, and high capacitance suitable for the use as a power supply can be realized.

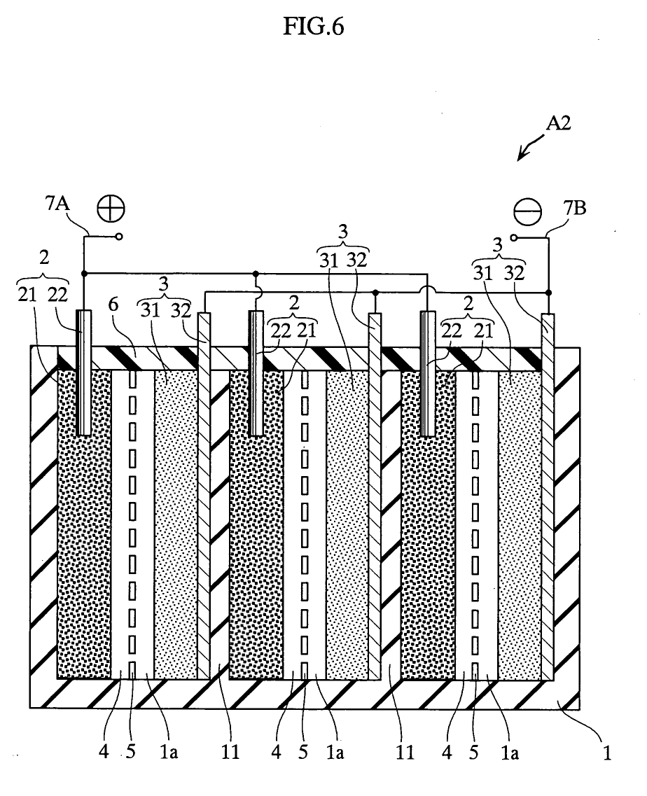

Instead of the structure shown in FIG. 5, as shown in FIG. 6, the cells in the structure shown in FIG. 4 may be connected in parallel by connecting the plurality of anode wires 22 to the terminal 7A while connecting the plurality of collector terminals 32 to the terminal 7B.

The electrolytic capacitor according to the present invention is not limited to the foregoing embodiments. The specific structure of each part of the electrolytic capacitor according to the present invention may be varied in various ways.

The material of the porous sintered body 21 is not limited to niobium, and use may be made of valve metal such as tantalum or a compound such as an oxide or nitride of valve metal.

To increase the capacitance, it is preferable to make the polarizable electrode 31 by using activated carbon. However, the present invention is not limited thereto, and any material can be used as long as it can form an electric double layer. As for the cathode 3, any material can be used as long as it can form an electric double layer, and the structure of the cathode is not limited to that including a polarizable electrode 31 and a collector electrode 32.

The electrolyte 4 is not limited to an aqueous solution of sulfuric acid, and other aqueous solutions or organic electrolyte using an organic solvent may be used. For instance, use may be made of known electrolyte generally used for a wet aluminum electrolytic capacitor.

1. An electrolytic capacitor comprising:
an anode and a cathode; and
an electrolyte provided between the anode and the cathode;
wherein the anode comprises a porous sintered body made of valve metal and formed with an oxide film as a dielectric layer on a surface of the body, the anode also comprising a first conductive member electrically connecting the porous sintered body to a positive external connection terminal;
wherein the cathode comprises a polarizable member for forming an electric double layer at an interface with the electrolyte, the cathode also comprising a second conductive member electrically connecting the polarizable member to a negative external connection terminal.

2. The electrolytic capacitor according to claim 1, wherein the electric double layer has a capacitance greater than a capacitance of the dielectric layer.

3. The electrolytic capacitor according to claim 1, wherein the valve metal is niobium, tantalum or a compound thereof.

4. The electrolytic capacitor according to claim 1, wherein the polarizable member of the cathode is made of activated carbon.

5. The electrolytic capacitor according to claim 1, further comprising a partition wall between the anode and the cathode, wherein the wall is passable to the electrolyte.

6. The electrolytic capacitor according to claim 1, further comprising a case divided into a plurality of chambers, wherein the anode, the cathode and the electrolyte are provided in each of the chambers of the case, and wherein the anode and the cathode in adjacent chambers are electrically connected in series to each other.

7. The electrolytic capacitor according to claim 1, further comprising a case divided into a plurality of chambers, wherein the anode, the cathode and the electrolyte are provided in each of the chambers of the case, and wherein the respective first conductive members of the anodes are electrically connected to each other, whereas the respective second conductive members of the cathodes are electrically connected to each other.

8. The electrolytic capacitor according to claim 1, wherein a plurality of anodes and a plurality of cathodes are provided, wherein the respective first conductive members of the anodes are electrically connected to each other, and wherein the respective second conductive members of the cathodes are electrically connected to each other.
